(19) United States
(12) Patent Application Publication
(10) Pub. No.: US 2025/0367855 A1
(43) Pub. Date: Dec. 4, 2025

(54) DISK STACK FOAMER APPARATUS USED IN MAKING CEMENTITIOUS FOAM

(71) Applicant: Terry P. Warner, Port Byron, NY (US)

(72) Inventor: Terry P. Warner, Port Byron, NY (US)

(21) Appl. No.: 18/680,276

(22) Filed: May 31, 2024

(51) Int. Cl. B28C 5/38

(52) U.S. Cl. CPC B28C 5/386

(57) ABSTRACT

The present invention is directed to a disk stack foamer system for controlling compressed air while making foam. From a bubble fluid and compressed air orifice, a first multi-orifice bulb discharges bubble fluid and compressed air while restricting air from expanding or amassing before entering a first disk stack. There are four chambers each containing two partitioned filter disk stacks. Disk stacks function progressively to each other in series. Downstream, discharged foam and compressed air run through a commercially available wye bubble reformer. In a cement and foam mixing wye, compressed air from the resistance of disk stacks is used by a second multi-hole bulb to temporarily separate foam in a comb-like fashion. A cement orifice slurry is able to wet against a majority of exposed foam, and thus make superior, homogeneous cementitious foam as discharged out of an application hose.

### FIELD OF THE INVENTION

The present application relates to foam production, more specifically systems for efficient production of cementitious foam.

### BACKGROUND

Cementitious foam, an integration of foam and cement, is commonly used for insulation purposes. Traditionally, cementitious foam is made by bubbling compressed air through an aqueous solution of bubble fluid with added silica fume (or other similarly small-micro sized minerals). This solution is frothed by aggregate fill in a foaming chamber, typically filled with glass beads. However, due to the presence of free compressed air used in traditional methods, pail life of the resulting foam is not maximized.

Traditional glass bead chambers allow for unnecessary coalescing of compressed air from a bubble fluid and air orifice, as well as a disordered mass stream of compressed air into a cement and foam mixing wye. This causes wasteful variances in the available working energy in the compressed air to make a more uniform cementitious foam.

Thus, a need for a system of cementitious foam production that controls the presence of free compressed air.

The presently disclosed invention utilizes multi-ported, or holed, globes to segment compressed air and bubble fluid. A first multi-orificed inlet bulb is placed centrally to the inside diameter of the first disk stack with little chamber gap between them. This provides forceful, metered streams of compressed air along with bubble fluid to more directly enter grooved rays of a disk stack. A second outlet bulb, through larger multi-ports typically 2 mm in diameter and placed intimately to a cement orifice within a cement and foam mixing wye, provides forceful, metered streams of compressed air that temporarily part the mutually injected and accumulated foam in an efficient manner for cement coating.

By utilizing a series of disk stacks, operators are better able to regulate the free compressed air on the input-side of an application gun. Grooves in paired disks are able to route free compressed air in a manner integral to bubble fluid surface encapsulated air forms and foams. This reduces the ability for compressed air to migrate en masse through the series of disk stacks. Rheology tests have shown that this system is more efficient in producing cementitious foam than traditional bead chambers. Additionally, the inventor has found that the pail life of foam produced in this novel manner is longer than that of foams produced with a bead chamber.

The quality of the cementitious foam can be determined through slump in five gallon test pails and by the amount of shrinkage and cracking of the product in open wall cavities during curing. The inventor found in side-by-side comparisons, foam produced through the disk stack was more stable, with less slumping, shrinking, and cracking than foam produced through traditional beaded chambers.

Another benefit of the presently disclosed system is that the grooves of independent disk stacks may be of different sizes. For example, due to an integrated high pressure air feed, a coarser variety of grooves may be used to break up agglomerated silica fume. The last pair of disk stacks in this case may have fine grooved rays to make high quality foam. The presence of stacks with varied groove sizes addresses varying needs for breaking up different sized minerals and their agglomerates while still producing a high-quality foam.

Another benefit of the stacked disk system is that due to their independent position in the last disk stack housing, disks with finer grooves may be easily removed for maintenance cleaning. This system not only allows for efficient production of cementitious foam, but also easy maintenance of the system after use.

In addition to cementitious foam production, the disclosed invention may also be used in other applications where bead chambers are traditionally used. For example, the disk stack apparatus may be used where compressed air or a gas as a component produces foam. This has applications in producing foam, to lubricate heads of tunnel boring machines, making of urea formaldehyde foam. Another application is firefighting foams that use mixing chambers.

### SUMMARY

Through multiple paired disks, each with radially symmetrical grooved rays angled opposite to each other to a central axis, the disk stacks of a disk stack foamer provide a common flow maze for bubble fluid and compressed air. The compressed air velocity is substantially greater than that of the bubble fluid and its generated surface tension held or exchanged air forms. On entering a set of radially spaced grooved rays from any paired disks of a first disk stack into its outside diameter, regardless of the initial grooved ray alignment positions, the bubble fluid and compressed air are forced to mutually enter or are in immediate succession to each other. Positions of a mutual alignment to non-alignment of grooved rays are encountered in the through travel. Foam, bubble fluid air forms and compressed air are discharged from these paired disks. In all disk stacks, this flow is either radially inward in paired disks to their inside diameters or radially outward in paired disks to their outside diameters.

After discharging from a first disk stack's inside diameter, the flow through of components in each disk stack of foam, bubble fluid air forms and compressed air, continues to be is severely disrupted in the scissor-like crossings of interfaced grooved rays in paired disks. The bubble fluid's inertia causes interlaced bubble fluid tensioned air forms from the compressed air. This is caused by it being slung or splashed against the changing directional geometry and being forcefully split apart in paired grooved channels that are partially to fully closed off to each other.

Further, consolidated compressed air not influenced meaningfully by bubble fluid surface tension, will move at a faster velocity than bubble fluid air forms and will change direction when its travel path is immediately interrupted or allowed to easily pass to an inside position. In a slower bubble fluid air form flow, which is weighted to the contours of changing geometry, the high energy compressed air pushes through it in a somewhat linear fashion. This gives high energy air the opportunity to cut across the grain within the turbulent and inertia slung bubble fluid air form flow. Foam and new bubble fluid air forms are manufactured along with a continuous discharge of compressed air.

In both the compressed air and the bubble fluid material, quality changes are due to the physical reactiveness of both components. This is induced primarily by frictional resistance between the two and the changing geometry of the intersecting grooved rays. In the disk stack foamer, pressure differentials are assumed to play a part in the foam making process as is the case in a bead chamber device. Although there are no aperture alignments such as between four mated glass beads that may produce bubble forms, there is a large population of generated pressure differentials between the compressed air and bubble fluid material.

As the compressed air pushes through this material, small amounts of it are caught as a surface tension bubble fluid skin and form bubbles. Because of the high energy within compressed air, this may in part be transferable surface tension compressed air segments throughout the progeny of bubble fluid air forms. With continuous repetition of these events in further travel through a disk stack maze, a majority of exchanging surface tension entities are fixed as homogeneous bubble forms and recognized as foam.

Without a foam making orifice, individual pressure differential incidences occur in substantial numbers within the maze. This bubble making capability is reliant on a continuous back pressure sustained specifically by the resistance of generated foam running through a specified length and diameter of an application hose. An example is an application hose 12 feet in length with an inside diameter of ⅞ inches. The back pressure holds a substantial portion of the compressed air energy intact for bubble air forms to be produced and expelled as foam. This back pressure is typically held at two atmospheres, approximately 30 P.S.I.

By trial and error, using a proprietary bubble fluid to make quality foam, that the number of disks to a stack has been established by the screen mesh equivalency of disks and disk diameters. For an example, testing a solitary disk stack using commercial disks each having 2.75 inch outside diameter with a 40 per linear inch screen mesh rating, and using four interfacing disks with the two end disks having flat machined or formed sealing faces for a total of five disks, produced a high quality foam. Another example is testing a solitary disk stack having 80 per linear inch screen mesh rated disks with outside diameters of 2.75 inch and using twelve interfacing disks with two end disks machined or formed sealing faces for a total of thirteen disks, produced excellent foam.

Two essential back pressures are necessary for the production of cementitious foam. The first back pressure is from the held back compressed air from a disk stack's geometrical and frictional resistance to it and the bubble fluid and surface tension air forms impediment to it, as they run together. The second back pressure is from the friction of cementitious foam mass in an application hose. Although surplus and or propellant air does ride concurrently with the cementitious foam, the travel path of the majority is to ring the inside diameter of the hose at its discharge end. Over airing will produce a “snow flake” outer ring around the discharged cementitious foam that has broken down under the force of compressed air.

The inventor initially found, after testing commercial filter disks of various outside diameters and equivalent mesh sizes and of different numbers of disks to a disk stack, that no composition and number of disks in a solitary stack could produce quality cementitious foam. For a proper cement coating, the inventor found that there was a lack of residual energy from compressed air to sufficiently explode open the foam in the mixing wye.

From the understanding of solitary disk foam performance, multiple disk stacks in series were tested, using commercial disks with 2.75 inch outside diameters and with interfaced grooved rays equivalent to a screen having a 40 or 80 screen mesh rating per linear inch. Two, four, and eventually eight disk stacks in series were tested. Input pressures for compressed air ranged from 75-83 P.S.I., bubble fluid from 78-88 P.S.I. and for cement from 72-105 P.S.I. Four disk stacks, each with eleven disks running in series, having 2.75 inch outer diameters and a 80 per linear inch screen mesh equivalency, produced an acceptable cementitious foam. However, there was little capacity to break up agglomerated silica fume and or other minerals added to the bubble fluid. Maintenance of the apparatus was also difficult. Disk stacks of equivalent 80 mesh screen plugged easily and thus the apparatus required a frequent disassembly for cleaning. What has been found is that 40 mesh screen rated disks in stacks and run in series are able to break up most agglomerates of silica fume and other minerals mixed into a bubble fluid. Importantly, without all of the compressed air being forced through the disk stacks and also simultaneously riding in a bubble fluid, producing a high quality foam in an efficient manner would not be possible.

A final assembly configuration of disk stacks was arrived at by the inventor. The two primary requirements were to find a proper total frictional resistance by the disk stacks for proper cement coating of foam, and to have disk stacks in the upstream side of the assembly capable of breaking up silica fume agglomerates and other mineral additions such as kaolin in the bubble fluid. An assembly of six disk stacks each having five disks rated at 40 mesh screen with 2.75 inch outside diameters, followed by two final disk stacks each having eleven disks rated at 80 mesh screen with 2.75 inch outside diameters fulfilled these two requirements.

From the inlet housing of the disk stack foamer, which is screwed into a first outer disk stack chamber housing, a bubble fluid and compressed air orifice is threaded in, central to a center axis. The input of the compressed air is added from a threaded port on the outside diameter radially inward to a position upstream to a nose collar containing radial slits. In the bore bottom is flat faced collar to an outside circular sealing rim, leaving rectangular through ports in the collar to dispense compressed air. Immediately downstream is a stainless steel pipe nipple is screwed in from the interior face of the inlet housing. A central orifice presents a highly agitated bubble fluid in confluence with compressed air from the multiple rectangular ports of the collar. At the nipple extension, the balance having been screwed into a threaded interior bore, a sealing O ring is contained in a machined groove in the nipple that is in line with a chamfer of the bore face.

A first bulb with a 1st multi orifice ported globe end is screwed on the male threaded nipple extension and bottoms out against the sealing O ring. The close proximity of the mounted bulb and its internal globe chamber to a bubble fluid and compressed air orifice allows a direct line of pressure to the orifice ports without expansion of the compressed air. An example is that this confluence enters forty orifice ports and is dispensed globally outward. These ports are radially in line to the center point of the globe portion with 0.057 inch (1.5 mm) inside orifice diameters. The equator of the globe face is located approximately 5/16 inch to the mid-section of the first disk stack's inside diameters within an internal cylindrical inlet enclosure.

The discharge from the first bulb is such that compressed air is broken up into multi-jets exiting the orifice ports of its globe simultaneously with bubble fluid. Because of the inherent back pressures in an inlet enclosure from disk stacks and application hose, there is little bias for a local group of orifice holes dispensing a majority of the compressed air and compressed air expansion is limited.

The bubble fluid and compressed air are injected in this example to inside circumferential entries of the grooved rays of four disk stack pairs with 2.75 inch outside diameters and rated at 40 mesh screen per linear inch. Bubble fluid and compressed air are projected to enter these grooved rays in a reasonable distributed fashion because of the two previously mentioned back pressures.

The upstream end of an internal cylindrical inlet enclosure is formed by a recess bore in the inlet housing for a first bulb. Surrounding this bore is a flat faced tube projection of the inlet housing with an outside diameter less than a threaded portion with sealing O ring, which is immediately behind it. A first outer disk stack housing on its upstream end has a counter bore and a female thread for joining to an inlet housing. The first disk face inline has a machined or formed flat face that seals against the flat faced tube projection as this housing is screwed into a first outside disk stack chamber housing.

The downstream end of this internal cylindrical enclosure is formed by a first spacer with flat face and a hemispherical central void to accommodate the end profile of the first bulb's globe. This spacer has an opposite end that is a solid cylindrical plug. The disk stack registers tightly against the flat end face of the spacer and is sealed off by the last disk face in line which has a machined or formed flat face. A second disk stack, in all respects a duplicate of the first disk stack, is held flat against a second flat face enjoined and extending from a cylindrical plug that is concentric to it, on the opposite side of the same first spacer.

The compaction and sealing off in unison of the two disk stacks is accomplished by screwing the inlet housing into the first outer disk stack chamber housing to an internal flat faced lip stop. This stop is machined flat to the inside of a solid, but bored out, cylindrical end projection with its accompanying outside thread and sealing O ring. A bore through has the same diameter as the inside diameters of the disks. The spacer's outer 2.75 inch rim diameter is centered or contained by four interior longitudinal evenly spaced ribs from a first outer disk stack chamber housing in order to orient itself to a central axis of this housing.

The disks of both disk stacks with the same 2.75 inch outside diameters are also held to this same central axis by means of these same four spacing ribs. A gap of less than ⅛ inch, preferably 0.08 inch, is maintained from the outside diameters of the disks and spacer to the inside diameter of the bored first outer disk stack chamber housing, excepting the area of the four longitudinal projected ribs. All outside annular enclosures have this 0.08 inch gap, less the area of the guiding longitudinal projected ribs in their periphery. A gap of less than ⅛ inch, preferably 0.10 inch, is maintained in all inside annular enclosures between disk inside diameters and plug outside diameters.

In relation to the inside diameters of the disk stacks, this distance is accomplished by solid cylindrical plug projections from spacers either to an upstream or downstream direction concentric to a central axis of the disk stack foamer. The inventor, using a solitary disk stack inside a tee strainer housing, found that this symmetry and these maintained distances were useful in generating quality foam.

The discharge of the first disk stack is into a first outside annular enclosure. This enclosure space uses an internal portion of a first outer disk stack chamber that also nests both a first and second disk stack. Within this enclosure, because of the sealing off of the two disk stacks from each other, foam, bubble fluid air forms, and compressed air bridge across the sealing spacer and are forced into outside circumferential entries of grooved rays in the second disk stack. These components travel inward through a second disk stack maze and are injected into a first inside annular enclosure.

The first inside annular enclosure has an outside diameter formed by the inside diameters of a second and third disk stack and a section between them. This section has a through bore in a solid cylindrical end projection of a first outside disk stack chamber housing. The projection has an outside threaded portion with sealing O ring. The bore is machined to the same inside diameter as the disks. This cylindrical end projection has two flat faces, one inside with its central bore and a second face on the outside end of the projection, having the bore exit central to it. These flat faces seal and space the two disk stacks to each other. The enclosure's inside diameter and length are formed by two solid cylindrical plugs, a first spacer's downstream plug and a second spacer's upstream plug, both with flat end faces. The first inside annular enclosure's upstream end is the flat sealing face of a first spacer facing downstream. The downstream end is the flat sealing face of a second spacer facing upstream. The discharge from a second disk stack of foam, bubble fluid air forms, and compressed air bridges the through bore and is forced into the inside perimeter of grooved ray entries of a third disk stack.

The components travel through a third disk stack maze and are injected radially outward from the outside perimeter of paired disks into a second outside annular enclosure. The second outside annular enclosure is a duplicate of a first outside annular enclosure with its four interior longitudinal evenly spaced guide ribs formed to an identical cylindrical length. This enclosure is in a portion of the upstream end of a center disk stack chambers housing. Its downstream end consists of a first flat sealing face of an internal cylindrical lip that projects from the mid-way point of a center disk stack chambers housing. Its inside diameter is less than the inside diameter of disks, but appropriately sufficient to seal off the downstream end of a fourth disk stack. Sealing off between a third and fourth disk stack are double sided flat faces of a second spacer's cylindrical rim projection, which extend radially outward from its cylindrical plug bodies. The upstream end of the enclosure is a flat end face of a first outer disk stack chamber housing, having the same dimensions as a flat end face of an inlet housing. As a first outer disk stack chamber housing with its outside threaded portion and sealing O ring is screwed into a center disk stack chambers housing, the compaction of a third and fourth disk stack is accomplished with a second spacer positioned between them.

From a third disk stack, foam, bubble fluid air forms, and compressed air bridge across a second spacer and are forced into the outer circumferential entries of the grooved rays in a fourth disk stack. These components travel inward through a fourth disk stack maze and are injected into a second inside annular enclosure.

This second inside annular enclosure has an outside diameter formed by the inside diameters of a fourth and fifth disk stack and a section between them. This section is the aforementioned internal cylindrical lip with two opposite flat sealing faces in the mid-section of the center disk stack chambers housing. The upstream end is the flat sealing face of a second spacer facing downstream. The downstream end is the upstream or first flat sealing face of a third spacer. The second inside annular enclosure's inside diameter and length are formed by two solid cylindrical plugs, a second spacer's downstream plug and a third spacer's upstream plug, both with flat end faces. The discharge from a fourth disk stack, foam, bubble fluid air forms, and compressed air bridge across the flat internal cylindrical sealing lip located in the mid-section of a center disk stack chambers housing and is forced into the inside perimeter of grooved ray entries of a fifth disk stack.

The fifth and sixth disk stacks are located in a downstream disk stack chamber; the second of two identical chambers in a center disk stack chambers housing. The upstream chamber contains a third and fourth disk stack as previously described. With this configuration, the chambers being identical, it is possible with identical second and third spacers, with their same length plug ends, to screw into a center disk stack housing at either end using a first or second outer disk chamber housings and maintain proper order with their carried disk stacks.

From a fifth disk stack, the discharge of the components is across and downstream into the outside perimeter of a sixth disk stack by way of a third outside annular enclosure. The flow is mechanically handled in an identical manner as that of a second outside annular enclosure involving a third and fourth disk stack.

A sixth disk stack discharges its components radially inward to a third inside annular enclosure. This enclosure functions mechanically the same as a first inside annular enclosure. The flow bridges across to the inside diameter entries of a seventh disk stack. As previously mentioned, in an example, the seventh and eighth disk stacks are composed of eleven disks with an 80 mesh screen per linear inch rating. The overall thickness of all disk stacks is identical, whether it is a 40 rated mesh screen five-piece disk stack or an 80 mesh screen rated eleven-piece disk stack. Because of the identical overall thickness and the same inside and outside diameters, these two types of disk stacks can be exchanged out in any disk stack chamber location in any apparatus without any mechanical changes.

Within a second outer disk stack chamber housing, traveling radially outward through a seventh disk stack maze, the components are discharged into a fourth outside annular enclosure and mechanically handled in an identical manner as that of a first outside annular enclosure. Within this enclosure, because the two disk stacks are sealed off from each other, foam, bubble fluid air forms, and compressed air bridge across this annular enclosure and are forced into outside circumferential entries of grooved rays in a eighth disk stack. The components travel radially inward through a last disk stack maze and are injected into the inside diameter volume void of the disk stack as foam and compressed air. Exiting the second outer disk stack chamber housing, the components travel downstream to an internal cylindrical discharge basin with a smaller through bore passageway. This final assembly is contained in a discharge housing.

A discharge housing has an outside threaded section with O ring and a flat face ring end and by screwing it into a second outer disk stack chamber housing, causing a compaction of a seventh and eighth disk stacks. The flat face has the same outside diameter as disks'. The inside diameter is greater than the disks', but sufficient for sealing off the downstream end of the eighth disk stack. The inside diameter of the flat face is formed by a bore ending as an internal face within the housing and forms a discharge basin chamber. This face in turn has an internal threaded through bore concentric to the center axis of the discharge housing. A plastic male threaded hex head nipple screws into this threaded bore to where its threaded end is flush to the inside entry of the bore. The hex nipple has a through hole that is the downstream conduit for foam and compressed air to a female coupler. This coupler has a through hole threaded at both ends and with lead-in counter bores for receiving sealing O rings. This is screwed onto a hex nipple's downstream end with its O ring sealing against it.

At the opposite end, a bubble resizing wye is screwed into the system. This may be a commercially available wye screen filter. The filter has a male threaded end with sealing O ring and an inlet hole that provides a conduit into the filter housing for foam and compressed air. The wye filter in an example has a screen rated 100 mesh per linear inch for reforming bubbles. After reforming the bubbles through a screen filter cartridge and conveying compressed air through it, the components are discharged out through an outlet hole. This outlet hole has a male threaded end with sealing O ring. A cement and foam mixing wye has a center bore with a counter bore entrance for the sealing O ring. A female threaded section in the first part of the center bore, allows a cement and foam mixing wye to be screwed and sealed to a bubble resizing wye.

Mounted into the filter outlet hole is a second bulb. This is the terminus of the disk stack foamer. In an example, foam and compressed air enter forty holes in the globe end of the bulb and are dispensed radially outward. These holes are radially in line to the center point of the globe portion with inside diameters at 0.078 inch (2 mm). This diameter size in the holes is to accommodate foam flow while simultaneously injecting multi-directed radially outward streams of high energy compressed air into a mixing wye. The bulb insertion into a foam and cement mixing wye is in line to its center bore and its depth, resulting in a position on the globe's outer face against the outer nose diameter of a cement orifice body. This intimacy assures a high energy separation of foam by means of the multi-streams of compressed air and thus allows cement to coat efficiently on an exposed surface area of foam. This arrangement of entities in combination with the described disk stack foamer produces a superior homogeneous cementitious foam product as dispensed out of an application hose end.

### BRIEF DESCRIPTION OF THE DRAWINGS

The present invention will be more fully understood and appreciated by reading the following Detailed Description in conjunction with the accompanying drawings, in which:

FIG. 1 is an overall partial section view of as disk stack foamer system;

FIG. 2A is an enlarged partial section view of FIG. 1 showing an inlet housing, first outer housing and partial center disk stack chamber housing;

FIG. 2B is an enlarged partial section view of FIG. 1 showing the remainder of the center disk stack chambers housing, discharge housing, male threaded hex nipple, and a partial view of the female threaded coupler;

FIG. 2C is an enlarged partial section view of FIG. 1 showing the remainder of the female threaded coupler and the bubble resizing wye;

FIG. 2D is an enlarged partial section view of FIG. 1 showing an inserted second bulb and projected forward to the inside center bore of the mixing wye;

FIG. 3 is an enlarged partial view of the central orifice port, circular sealing rim, and nose collar with radial slits;

FIG. 4 is a sectional view of the internal circuitry of eight disk stacks within chambers depicting flow of components, bubble fluid, foam and compressed air;

FIG. 5 is an illustrative representation of bubble fluid and compressed air entering the interface of two grooved rays located at the inside diameters of two paired disks. This illustration is magnified twenty to one and fifty to one for better visual understanding;

FIG. 6 depicts a partial sectional view of the first globe, with an exploded view of the first disk stack and a sectional view of the second disk stack and first outer disk stack chamber housing;

FIG. 7 depicts a sectional view of the seventh disk stack and second outer disk stack chamber housing with an exploded view of the eighth disk stack.

### DETAILED DESCRIPTION

Referring now to the drawings, wherein like reference numerals refer to like parts throughout, the present invention is a novel disk stack foamer apparatus that integrates foam and cement to produce cementitious foam for insulation purposes. The disk stack foamer leverages stacks of paired disks having grooved channels to mix bubble fluid and compressed air to produce foam. By utilizing stacked disks, the resulting foam produces high quality cementitious foam in an efficient and easy to maintain manner.

The disk stack foamer uses three components to produce the cementitious foam. The first component is an aqueous solution of calcium chloride with a proprietary expanding agent. Additions of silica fume and other similarly small micro size minerals ride in this aqueous solution to extend foam pot life and to improve the integration of the cement to the bubble.

The second component is compressed air. When the first mentioned aqueous solution and compressed air are forced through the disk stack foamer, high quality foam and residual high energy air streams are expelled radially outward from a multi-ported globe at the terminus of the foamer in a mixing wye.

The third cement component is forcefully injected against compressed air fragmented foam in a mixing wye.

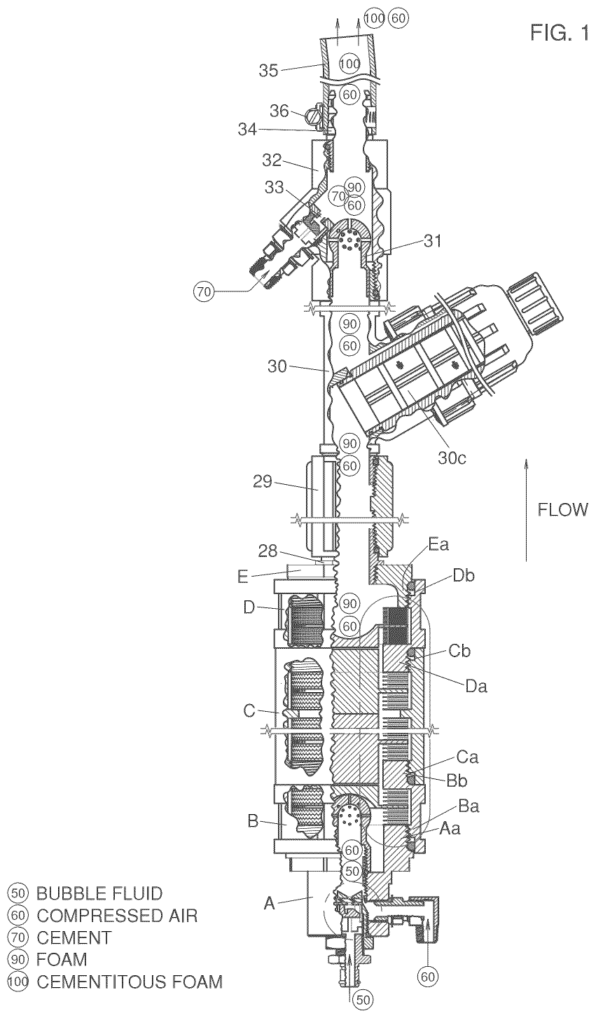

Referring now to FIG. 1, bubble fluid 50 and compressed air 60 at the input end of the disk stack foamer and foam 90 at its discharge end are defined components, including their representational routing lines. Bubble fluid air forms are not labeled in the figures because of their transitional and temporary presence throughout the disk stacks and their interconnected circuitry. It is difficult to measure quantitatively or describe qualitatively bubble fluid air forms as a component or as a product of a foaming system. Bubble fluid air forms may be considered a mixture of turbulent foam 90 and compressed air 60 as described herein. However, an awareness of their nature is useful in understanding the dynamics involved in making foam through a disk stack foamer. This results in a highly homogenous cementitious foam product as discharged out of an application hose.

Depicted in FIG. 1 is a mechanical representation of the disk stack foamer. Inlet housing A has a male threaded section with sealing O ring Aa for screwing into a counter bore and a female threaded section Ba of a first outer disk stack chamber housing B. A first outer disk stack chamber housing has a male threaded section with sealing O ring Bb for screwing into a first counter bore and female threaded section Ca of center disk stack chambers housing C. A second outer disk chamber housing D has a male threaded section with sealing O ring Da for screwing into a second counter bore and female threaded section Cb of center disk stack chambers housing C. A male threaded section with sealing O ring Ea of discharge housing E is screwed into a counter bore and female threaded section Db of 2nd outer disk stack chamber housing. Having the same male threads with O rings and the same female threads with their counter bores, all male to female threaded housings may be interchanged by screwing them together.

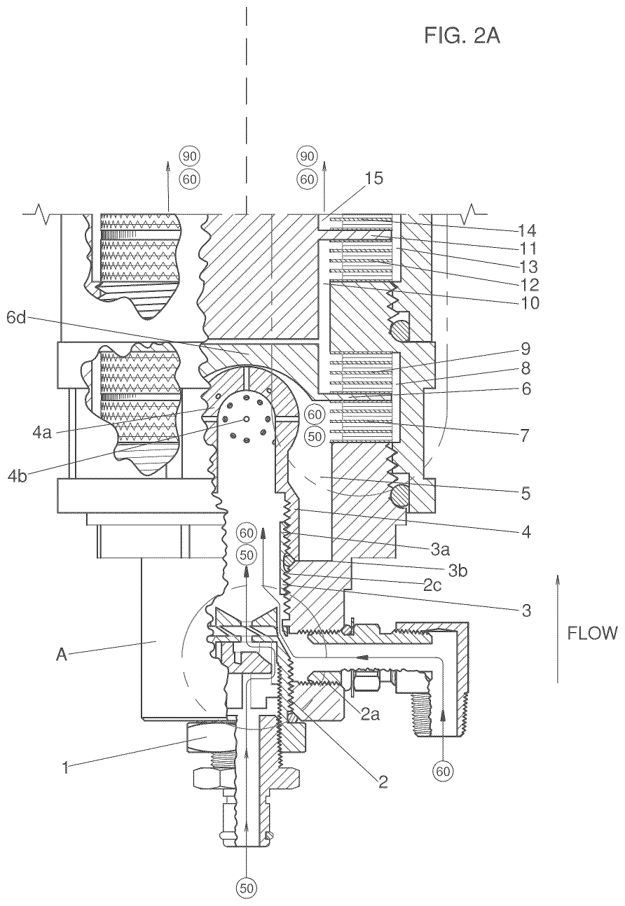

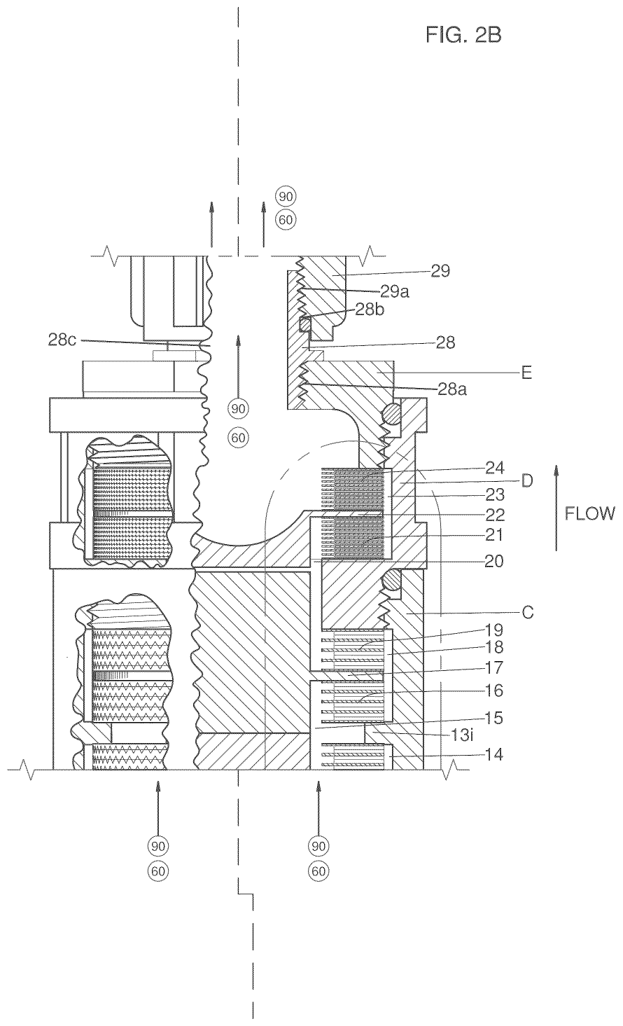

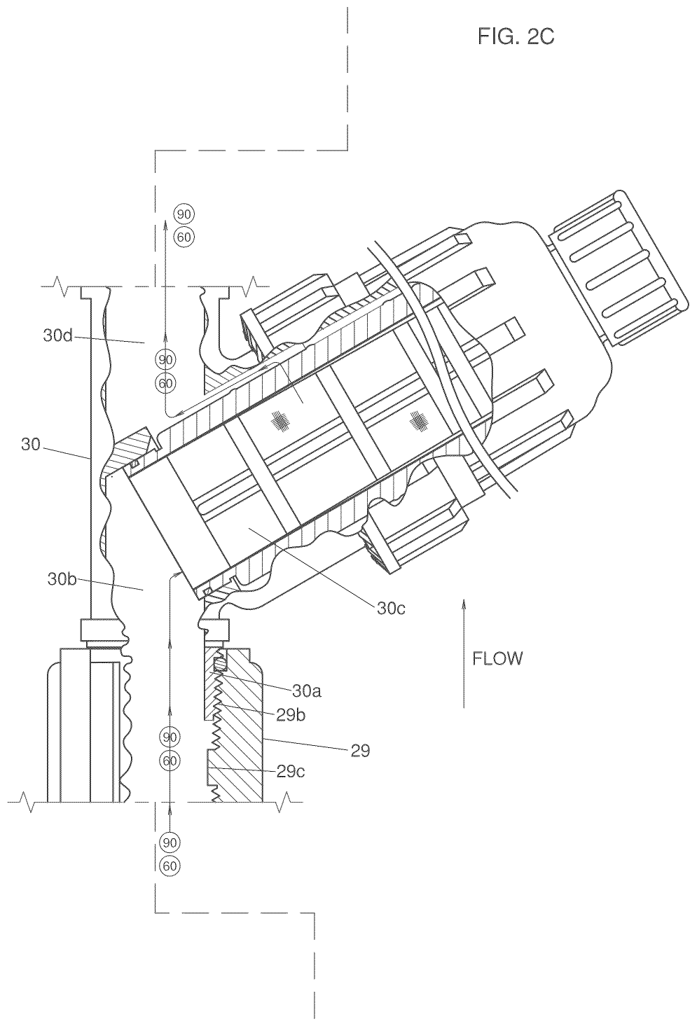

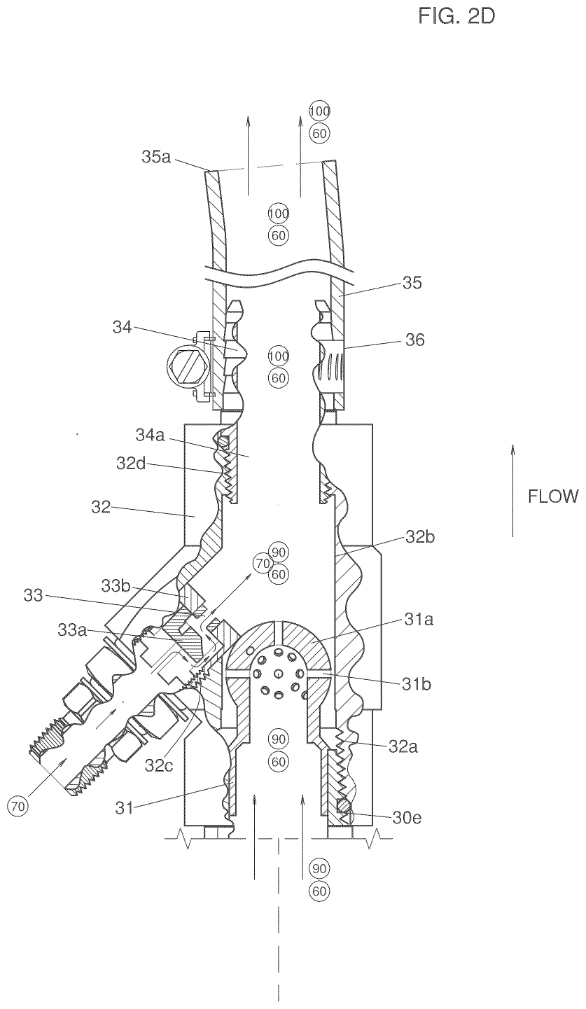

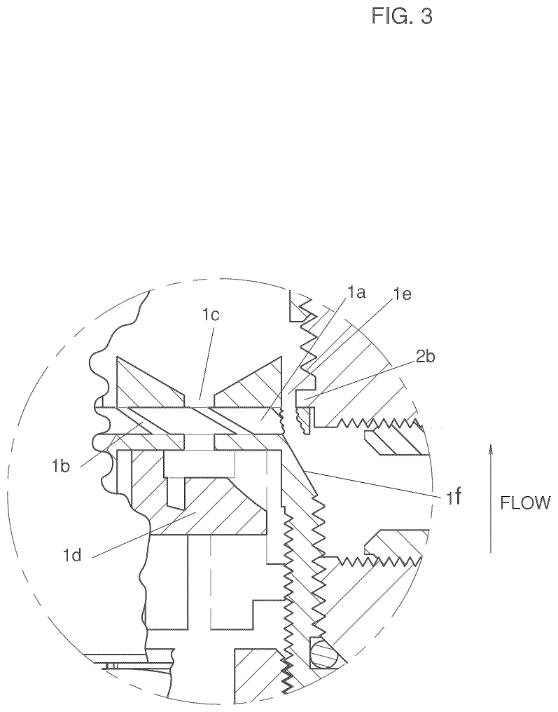

As illustrated in FIGS. 2A and 3, a bubble fluid and compressed air orifice 1 is screwed into a central threaded bore 2 of an inlet housing. The input of the compressed air 60 is routed from a threaded port 2a extending from the outside diameter of the inlet housing, inward to this central threaded bore in line to an angled relief 1f, machined in the orifice upstream of its nose collar 1a. The nose collar with its radial slits 1b, is sealed off against a circular sealing rim 2b, forming compressed air rectangular ports 1e, at the bottom of this bore. Compressed air is forcefully injected through these slits forward to forcefully mix with bubble fluid from a central orifice port 1c. Seated upstream at the entrance of this central orifice is a fluid spinner 1d. A pipe nipple 3 is screwed into a threaded central bore with a face chamfer 2c. A portion of the pipe nipple 3 extends downstream 3a with a sealing O ring 3b. A first bulb 4 is screwed on to the pipe nipple extension and against the sealing O ring. First multi-orifice port globe 4a of a bulb 4, in an example, has forty orifice ports 4b with 0.057 inch (1.5 mm) diameters. Bubble fluid 50 and compressed air 60 are forcefully injected radially outward from the center point of globe 4a with its equator in line with the mid-section of the first disk stack 7. This arrangement guarantees the close proximity of this globe to the inside diameters of the disk stack 7c. The result is little expansion or compression loss, and multiple streams of compressed air 60 are able to enter the grooved rays of disk pairs with high energy. Multiple streams of bubble fluid 50 from these same orifices are conveyed and turbulently entwined by the compressed air to these same grooved rays of disk pairs.

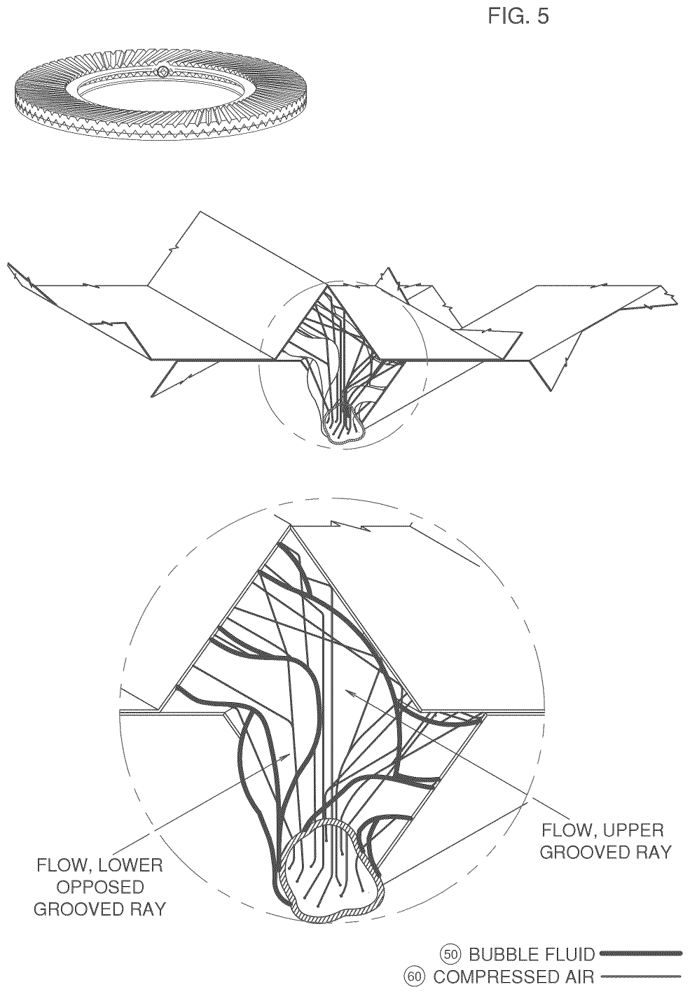

FIG. 5 illustrates the interaction of compressed air 60 and bubble fluid 50 forced under pressure between two grooved rays from a typical paired disk interface. Bubble fluid 50 is referenced by heavy lines and compressed air 60 by lighter lines in said illustrated the figures.

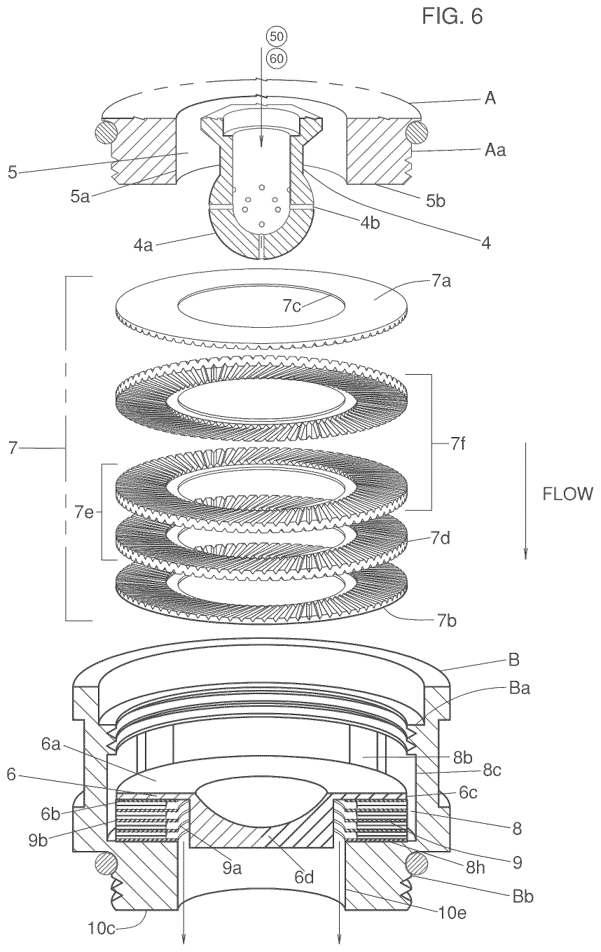

In FIG. 6, the first disk stack 7 has a disk pair 7e and disk pair grooved rays 7f displaying their angular opposition. As depicted, this angular opposition originates from the positioning of each disk to each other as a pair.

As depicted in FIGS. 2A, 4, and 6, a space for a 1st bulb to expel bubble fluid and compressed air to a first disk stack inside diameters 7c is an internal cylindrical inlet enclosure 5. The upstream end of the inlet enclosure is a recess bore 5a, in an inlet housing. The outer cylindrical confine of this bore is a flat faced tube projection 5b. The inside diameters of a first disk stack 7c is a continuation of the recess bore to a downstream end, leading to a flat sealing face with hemispherical void 6a of a first spacer 6. As shown in FIG. 6, sealing off the ends of the first disk stack 7 is a flat sealing face on a first disk 7a and a flat sealing face on a last disk 7b.

These first and last flat sealing faces are present in all disk stacks. In an example, the disks of first, second, third, fourth, fifth, and sixth disk stacks are equivalent to 40 mesh screen openings per linear inch. The disks of seventh and eighth disk stacks are equivalent to 80 mesh screen openings per linear inch. The same overall thickness of disk stacks is maintained regardless of mesh screen equivalencies. In this example, there are five disks rated at a 40 mesh screen in each of the first six disk stacks and eleven disks rated at 80 mesh screen in each of the last two disk stacks.

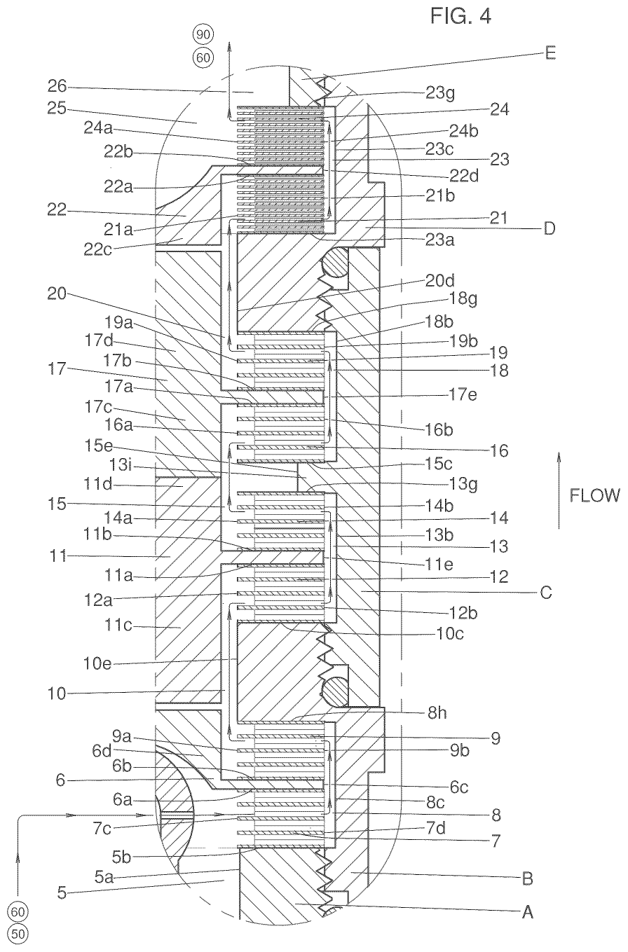

As detailed in FIGS. 4 and 6, pressurized in this inlet enclosure the bubble fluid 50 and compressed air 60 are forcefully injected into disk pairs and exit through to the outside diameters of a first disk stack 7d into a first outside annular enclosure 8. Reconstituted as a flow of fragmented compressed air 60, bubble fluid air forms and foam 90, this agglomeration bridges across this annular enclosure to the outside diameters 9b of a second disk stack 9. Pressurization is maintained within the bounds of the enclosure. The upstream end is the flat faced tube projection 5b of an inlet housing A. The downstream end is an internal flat faced lip stop 8h of a first outer disk stack housing B. Within a first outer disk stack housing B, the outside perimeter of the annular enclosure is formed by a bored chamber 8c with four equally spaced guide ribs 8b that center the disks of first and second disk stacks and a first spacer 6. Two of four guide ribs 8b in FIG. 6 depict this arrangement. The inside diameter of this annular enclosure is defined by outside diameters of the first disk stack 7d and second disk stack 9b with the guide rim 6c of a first spacer 6, positioned in between. The first spacer's first flat sealing face with hemispherical void 6a seals against the downstream end of a first disk stack 7 and the first spacer's second flat sealing face 6b seals against the upstream end of the second disk stack 9.

As described in FIGS. 4, 2A, and 2B, the travel through a second disk stack is inward and discharged from its inside diameters 9a into a first inside annular enclosure 10. This flow of foam 90, bubble fluid air forms and compressed air 60 bridges through the annular enclosure, to the inside diameters 12a of a third disk stack 12, where the components enter under pressure. This third disk stack is located in a bored chamber, upstream end 13b of a center disk chambers housing C. The upstream end of the first inside annular enclosure is a second flat sealing face 6b of a first spacer and the downstream end is an upstream sealing face 11a of a second spacer 11. The outer perimeter of the enclosure is the inside diameters 9a of the second disk stack, bore 10e of a first outer disk stack chamber housing's flat faced tube projection 10c and the inside diameters 12a of a third disk stack 12. The inner perimeter of the enclosure is the cylindrical plug 6d of the first spacer 6 and the upstream cylindrical plug 11c of the second spacer 11. Positioned in between and sealing off the downstream end of the second disk stack and the upstream end of the third disk stack, are two sealing faces; an internal flat faced lip stop 8h and a flat faced tube projection 10c.

The discharge of said components radially ejected from outside diameters 12b of the third disk stack 12, is into a second outside annular enclosure 13. The pressurized agglomeration travels within the boundaries of the enclosure across to the entries of the outside diameters 14b of a fourth disk stack 14. The enclosure space is a duplicate of a first outside annular enclosure. All disk stack chambers with their four equally spaced guide ribs are dimensionally identical in all respects. For example, in FIG. 6, two of four guide ribs 8b represent this duplication of guide ribs in all disk stack chambers. The second outside annular enclosure's outside perimeter is a bored chamber, upstream end 13b, of a center disk stack chambers housing C. Four guide ribs center the disks of the third disk stack 12 of a second spacer 11, and the disks of a fourth disk stack 14. The inside diameter of the enclosure is bounded by outside diameters 12b of a third disk stack, guide rim 11e of a second spacer 11 and the outside diameters 14b of a fourth disk stack 14. The upstream end is the flat faced tube projection 10c of a first outer disk stack chamber housing B. The downstream end is an upstream internal flat sealing face 13g of internal cylindrical lip 13i, located in the mid-section of a center disk stack chambers housing C. Positioned between the third and fourth disk stacks are an upstream flat sealing face 11a and a downstream flat sealing face 11b of a second spacer 11.

Foam 90, bubble fluid air forms, and compressed air 60 travel through the fourth disk stack's paired disks and are expelled radially inward at the inside diameters 14a into a second inside annular enclosure 15. The components flow through the enclosure downstream under pressure to the entries of the inside diameters 16a of a fifth disk stack 16. The upstream end of the enclosure is the downstream flat sealing face 11b of a second spacer 11 and the downstream end is the upstream flat sealing face 17a of a third spacer 17. A second inside annular enclosure has an outer perimeter formed by the inside diameters 14a of a fourth disk stack, positioned in between the inside diameter 15e of internal cylindrical lip 13i and the inside diameter 16a of a fifth disk stack.

The inner perimeter of the enclosure is the downstream cylindrical plug 11d of a second spacer 11 and the upstream cylindrical plug 17c of a third spacer 17. Positioned in between and sealing off the downstream end of a third disk stack and the upstream end of a fourth disk stack are two flat faces of internal cylindrical lip 13i, upstream sealing face 13g and downstream sealing face 15c. Internal cylindrical lip 13i is positioned in the middle of center disk stack chambers housing C and as a result a second inside annual enclosure is evenly divided between the upstream end and downstream end of a center disk stack chambers housing. Also, the downstream end of a second inside annular enclosure is a mirror image of an upstream end.

A center disk stack chambers housing is designed so that the geometry of the downstream half is an identical mirror image of the upstream half. Essentially, either end of a center disk stack chambers housing can be screwed into an assembly of the disk stack foamer without any difference in the containment and functioning of the enclosed disk stacks.

The discharge of the components from the outside diameters 16b of a fifth disk stack 16 is forcibility and radially expelled into a third outside annular enclosure 18 and, under pressure, travels downstream to the outside diameters 19b of a sixth disk stack 19. The mechanical geometry used in forming the space of a third outside annular enclosure 18 is a mirror duplicate of a second outside annular enclosure 13. The outside perimeter is a bored chamber at the downstream end 18b of a center disk stack chambers housing C. Four equally spaced guide ribs, as shown in FIG. 6, center the disks of a fifth disk stack 16, of a third spacer 17, and the disks of a sixth disk stack 19. The inside diameter of the enclosure is bounded by the outside diameters 16b of a fifth disk stack, guide rim 17e of a third spacer 17 and the outside diameters 19b of sixth disk stack 19. The upstream end is the downstream flat sealing face 15c of internal cylindrical lip 13i. The downstream end is the flat faced tube projection 18g of a second outer disk stack chamber housing D. Positioned between a fifth and sixth disk stack are an upstream flat sealing face 17a and a downstream flat sealing face 17b of third spacer 17.

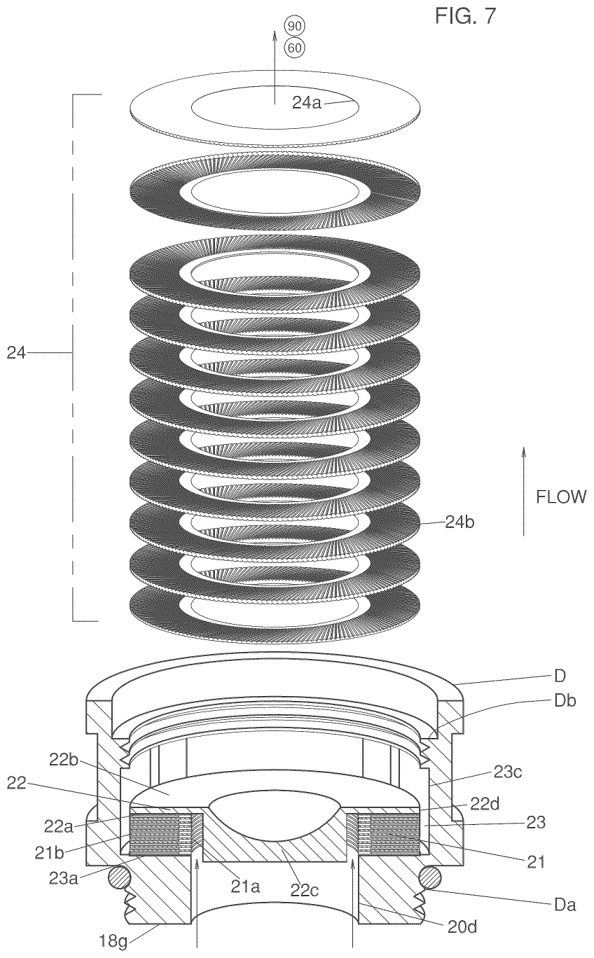

Foam 90, bubble fluid air forms, and compressed air 60 travel through a sixth disk stack's paired disks and are expelled radially inward at the inside diameters 19a into a third inside annular enclosure 20. Depicted in FIGS. 4, 2B, 7 and 2C, these components under pressure travel downstream through the enclosure to the inside diameters 21a of paired disks forming a seventh disk stack 21. In this example, the disks of a seventh disk stack 21 are equivalent to a mesh screen of 80 openings per linear per inch. The mechanical geometry used in containing the space of a third inside annular enclosure 20 is a mirror duplicate of a first inside annular enclosure 10. This sixth disk stack 19 is located in a bored chamber, at the downstream end 18b of center disk stack chamber housing C and a seventh disk stack is located in a bored chamber 23c of a second outer disk stack chamber housing.

The upstream end is a downstream flat sealing face 17b of a third spacer 17 and the downstream end is an upstream flat sealing face 22a of fourth spacer 22. The outer perimeter of the enclosure is the inside diameters 19a of a sixth disk stack 19, bore 20d of a second outer disk stack chamber housing's flat faced tube projection 18g and the inside diameters 21a of a seventh disk stack 21. The inner perimeter of the enclosure is the downstream cylindrical plug 17d of a third spacer 17 and the cylindrical plug 22c of a fourth spacer 22. Positioned in between and sealing off the downstream end of a sixth disk stack and the upstream end of a seventh disk stack are two sealing faces; a flat faced tube projection 18g and a downstream internal flat faced lip stop 20e of a second outer disk stack housing.

Pressurized discharge of foam 90, bubble fluid air forms, and compressed air 60 from the outside diameters 21b of paired disks of a seventh disk stack 21 are radially dispensed into a fourth outside annular enclosure 23. The agglomeration travels through this annular enclosure to the outside diameters 24b of paired disks that form an eighth disk stack 24. In this example, disks of an eighth disk stack are equivalent to 80 mesh rated screen. A fourth outside annular enclosure 23 is an exact mirror duplicate by volume and dimensions compared to the first outside annular enclosure 8.

The upstream end is an internal flat faced lip stop 23a of a 2nd outer disk stack chamber housing D and the downstream end is the flat faced tube projection 23g of a discharge housing E. Within the second outer disk stack chamber housing D, the outer perimeter of the enclosure is formed a bored chamber 23c with four equally spaced guide ribs to center the disks of the seventh and eighth disk stacks and a fourth spacer 22. The inside diameter of this annular enclosure is formed by outside diameters of the seventh disk stack 21b and eighth disk stack 24b with the guide rim 22d of a fourth spacer 22 positioned in between. A fourth spacer's upstream flat sealing face 22a seals against the downstream end of seventh disk stack 21 and a fourth spacer's flat sealing face with hemispherical void 22b seals against the upstream end of eighth disk stack 24.

Depicted in FIGS. 4, 2B, 7 and 2C, Foam 90, bubble fluid air forms, and compressed air 60 travel through an eighth disk stack 24 and are discharged out of the paired disks inside diameters 24a into an inside diameter volume 25. The inside diameter volume's cylindrical form is contained by the inside diameters 24a of eighth disk stack 24. The upstream end is the flat sealing face with hemispherical void 22b of a fourth spacer 22. The downstream end is a continuation of this volume into an internal discharge basin 26 of discharge housing E and a downstream through bore 28c of male threaded hex head nipple 28 that is threaded into housing E. Discharge housing E has a threaded bore through 27 for screwing in the first male threaded end 28a of male threaded hex head nipple 28. A second male threaded end with an O ring 28b of a threaded hex head nipple 28 allows a female threaded coupler 29 having a first counter bore with female threaded section 29a to be screwed together. A threaded female coupler 29 has a through bore 29c for continued downstream conveyance of foam 90 and compressed air 60. At its opposite end is a second counter bore with female threaded section 29b.

Ending of enclosure confinement coming out the inside diameters 24a of the eighth disk stack 24, the downstream flow of said components allows a collective volume of compressed air to come out of the bubble fluid air forms into more defined streams. While there is a constant back pressure against the components, unoccupied compressed air or weak surface tensioned fluid air forms, if not mechanically agitated (i.e. using paired disks) will result in these more defined streams of compressed air. This causes the product in its majority to segregate into uniform foam with compressed air streams running downstream through it. An example of this is the visual witnessing of pressured air streams in a clear view polycarbonate glass bead chamber. The tube's inside diameter provides a skin interface where beads are not able to maintain a uniform matrix of bead-to-bead contact. With less resistance along this inside cylindrical interface, displaced foam and bubble fluid air forms show the visual outlines of compressed air streams.

Previously, as described in U.S. Pat. No. 9,540,281 for reforming foam, using a commercially available wye screen filter allows a filter to be used for this purpose. FIG. 2C depicts a bubble resizing wye 30. With a first male threaded end with sealing O ring 30a, bubble resizing wye 30 is designed to be screwed together to a female threaded coupler 29. From an inlet hole 30b, foam and compressed air are able flow through a cylindrical screen 30c rated at 100 mesh screen openings per linear inch for reforming bubbles of foam, while allowing compressed air unrestricted passageway. In this example, this is possible because of the large 16.75 square inches of cylindrical screen surface area. The inlet hole 30b directs the flow of foam 90 and compressed air 60 to the filter's inside core and from this position is expelled radially outward through screen meshes. Back pressure against flow through the screen meshes is maintained by the resistance of cementitious foam product in the application hose. Confirmed in tests using pressure gages, average low-pressure differentials across screen meshes is typically two pounds per square inch, thus assuring finer reformed bubbles that coalesce back together as foam. Foam 90 and streams of compressed air 60 travel out of the filter housing by means of outlet hole 30d.

As depicted in FIG. 2D there is a second bulb 31 with a second multi-hole globe 31a, having forty 0.078 inch (2 mm) holes 31b. This second globe is mounted into the inside diameter of the outlet hole 30d (as shown in FIG. 2C). The size of the holes' inside diameters is sufficient to allow foam 90, to be jettisoned through while simultaneously allowing a majority of compressed air 60 to ring through the inside diameters of the holes. A visual representation of this is “snow flakes” caused by over pressurizing the air in an application hose. Ringing the inside diameter, compressed air shows itself by breaking up cementitious foam at this interface of the foam and hose surface. The result at the application hose end is seeing a cementitious foam running through an outer circle of radiated “snow flakes”. Another visual representation of this phenomenon is the previously mentioned example of compressed air coalescing in streams against the interior surface of a bead chamber. This ability of multi-dispensed foam to be segregated by multiple high pressure air streams exposes large surface areas of foam to incoming high pressure orifice cement.

A cement and foam mixing wye 32 has an entry counter bore with a female threaded section 32a for threading together with the second male threaded end with sealing O ring 30e of a bubble resizing wye 30. Cement and foam mixing wye 32 has a center bore 32b, a female threaded bore hole 32c for cement orifice 33 and a female threaded outlet bore hole with O ring chamfer 30d. As assembled, the second multi-orifice bulb 31, from its seating in outlet hole 30d, projects its globe 31a into the throat of center bore 32a to a distance that positions itself against cylindrical body 33b of cement orifice 33. This intimacy in a cement and foam mixing wye center bore 32b to a cement orifice 33 and its cement spinner 33a provides a necessary condition for maximizing a homogenous wetting of pressurized cement 70 to a greatly exposed foam 90 surface area.

The second multi-hole globe 31a with its 0.078 inch holes 31b of a second bulb 31 is the terminal end of the disk stack foamer. However, using its strategic positioning and multi-holes in a previously designed wye's center bore 32b in this novel way, combined with the back pressure of product in an application hose 35, allows a final action of a disk stack foamer in making a superior homogenous cementitious cement 100 as discharged out of application hose end 35a. Included in this discharge is a propellant remainder of compressed air 60. These two components cementitious foam 100 and compressed air 60, Hose barb having a male threaded end with O ring 34 is screwed into a female threaded outlet bore hole with O ring chamfer 32d of a cement and foam mixing wye 32. A through bore 34a in the hose barb 34 conveys the product to an application hose 35. A hose clamp 36 secures the application hose 35 to the hose barb 34.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A disk stack system for producing foam, the system comprising:
an inlet housing comprising a bubble fluid orifice and a compressed air orifice;
a first globe in fluid connection with the inlet housing,
wherein the first globe comprises at least one port capable of ejecting a mixture of bubble fluid and compressed air radially outward from a center point;
a disk stack in fluid connection with the first globe, the disk stack comprising at least one disk pair,
wherein individual disks of the disk pair comprise grooved rays aligned to create a channel between the individual disks of the disk pair,
wherein the disk stack comprises an inner cylindrical enclosure;
an outer annular enclosure in fluid connection with the disk stack and positioned around the outer diameter of the disk stack; and
a second globe in fluid connection with the disk stack,
wherein the second globe comprises at least one port capable of ejecting the mixture of foam and compressed air radially outward from a center point.

2. The system of claim 1, wherein the disk stack is positioned with its midsection in line with an equator of the first globe.

3. The system of claim 1 further comprising:
a second disk stack in fluid connection with the first disk stack,
wherein fluid flows radially inward from the annular enclosure toward a central annular opening at the center of the second disk stack.

4. The system of claim 1 further comprising:
n disk stacks,
wherein fluid travels radially outward from odd disk stacks, and
wherein fluid travels radially inward in even disk stacks.

5. The system of claim 1 further comprising:
a wye screen filter positioned between the disk stack and the second globe in fluid connection with the disk stack and the second globe.

6. The system of claim 1 further comprising:
a discharge housing in fluid connection with the second globe.

7. The system of claim 1 further comprising a first bulb in fluid connection with the first globe,
wherein an outside diameter of the first bulb is positioned midway inside the inner cylindrical enclosure.

8. The system of claim 1, wherein the first globe comprises multiple ports,
wherein the ports are spherically patterned, and
wherein an individual axis of each port is in line with a center point within the first globe.

9. The system of claim 1 further comprising:
a first sealing face positioned upstream of the disk stack,
wherein the first sealing face is machined from an upstream disk stack face; and
a second sealing face positioned downstream of the disk stack,
wherein the second sealing face is machined from a downstream disk stack face.

10. The system of claim 1 further comprising:
at least one disk stack spacer,
wherein the disk stack spacer comprises one or more guide rims,
wherein the guide rims each comprise two disk stack sealing faces.

11. The system of claim 10 further comprising:
one or more disk stack spacer plugs positioned concentric to the guide rims.

12. The system of claim 1, wherein the disk stack is continuously charged with two or more of: bubble fluid, bubble fluid air forms, foam, and compressed air.

13. The system of claim 1, wherein the disk stack continuously discharges two or more of: bubble fluid, bubble fluid air forms, foam, and compressed air.

14. The system of claim 1, wherein the disk pair is continuously charged with two or more of: bubble fluid, bubble fluid air forms, foam, and compressed air.

15. The system of claim 1, wherein the disk pair continuously discharges two or more of: bubble fluid, bubble fluid air forms, foam, and compressed air.

16. The system of claim 4, wherein the annular enclosures of each disk stack are separated by a sealing spacer.

17. The system of claim 1, wherein the annular enclosure continuously discharges two or more of: bubble fluid, bubble fluid air forms, foam, and compressed air.

18. The system of claim 1, wherein the disk stack may be interchangeable with a disk stack of a different screen mesh equivalency.

19. The system of claim 4, wherein one or more upstream disk stacks has or have a coarser screen mesh equivalency than downstream disk stacks.

20. The system of claim 4, wherein n=8,
wherein the first 6 disk stacks are rated 40 per inch screen mesh, and
wherein the last 2 disk stacks are rated 80 per inch screen mesh.

21. The system of claim 7 further comprising:
a second bulb in fluid connection with the second globe,
wherein the second bulb is positioned center to a center axis in a cement and foam mixing wye.

22. The system of claim 1, wherein the second globe comprises multiple ports,
wherein the ports are spherically patterned, and
wherein an individual axis of each port is in line with a center point within the second globe.

23. The system of claim 1, wherein the second globe is positioned upstream of a discharge end of a cement orifice body.
